(19) United States
(12) Patent Application Publication
(10) Pub. No.: US 2026/0161147 A1
(43) Pub. Date: Jun. 11, 2026

(54) PROGRAMMABLE LOGIC CONTROLLER, CONTROL METHOD, AND RECORDING MEDIUM

(71) Applicant: Mitsubishi Electric Corporation, Tokyo (JP)

(72) Inventor: Tomoaki TAKAGI, Tokyo (JP)

(73) Assignee: Mitsubishi Electric Corporation, Tokyo (JP)

(21) Appl. No.: 18/723,487

(22) PCT Filed: May 26, 2022
(86) PCT No.: PCT/JP2022/021611

§ 371 Date: Jun. 24, 2024

(51) Int. Cl. G05B 19/05; G06F 21/44

(52) U.S. Cl. CPC G05B 19/05; G06F 21/44

(57) ABSTRACT

A read request information receiver receives, from an external device, read request information for reading read-target information. A secured information generator generates, when the read-target information includes confidential information, secured information being the confidential information converted into a secure form. A response information transmitter transmits the read-target information as response information when the read-target information includes no confidential information, and transmits, as response information, the read-target information with the confidential information replaced with the secured information when the read-target information includes the confidential information.

### TECHNICAL FIELD

The present disclosure relates to a programmable logic controller, a control method, and a program.

### BACKGROUND ART

At factories, programmable logic controllers (hereafter may be referred to as PLCs) are used as control apparatuses for controlling equipment that automates production processes, such as machining tools and manufacturing devices. Such PLCs include random-access memories (RAMs) storing information about production of products such as control information for equipment and recipe information indicating the temperature and mixing ratio of materials inside the equipment. The information in the RAMs or other devices included in the PLCs is thus read periodically by external devices in production monitoring systems such as supervisory control and data acquisition (SCADA) to determine whether the production systems are operating normally.

The devices in typical PLCs also store, as the production information described above, know-how information held by manufacturers, such as a control method for equipment and a manufacturing method for products using the equipment. PLCs are to appropriately protect information to be confidential, such as know-how information, from third parties. Patent Literature 1 describes an example of such a PLC that permits users who have been successfully authenticated to read and write data in a device.

### CITATION LIST

### Patent Literature

Patent Literature 1: International Publication No. WO 2014/016938.

### SUMMARY OF INVENTION

### Technical Problem

The PLC described in Patent Literature 1 performs authentication each time the device data is to be read or written. When, for example, the PLC described in Patent Literature 1 includes many devices as in a large-scale production system, the PLC may have a higher processing load of authentication performed upon each access request to read and write from and to the devices in short cycles. The PLC described in Patent Literature I can thus have, for example, a higher latency, or more specifically, a longer response time from when an external device used by a user requests to read and write data to when the PLC responds, or have a longer time to scan data stored in the devices. Such a PLC described in Patent Literature 1 with a higher processing load to read and write data from and to the devices can also have delays in sequence control, or sequentially controlling the equipment.

Under such circumstances, an objective of the present disclosure is to reduce the processing load while protecting information to be confidential from third parties.

### Solution to Problem

To achieve the above objective, a programmable logic controller according to an aspect of the present disclosure is a controller capable of transmitting and receiving information to and from an external device. The programmable logic controller includes a read request information receiver to receive, from the external device, read request information indicating a request for reading read-target information. The read-target information is information to be read. The programmable logic controller also includes a secured information generator to generate, when the read-target information includes confidential information being information to be in a confidential range, secured information being the confidential information converted into a secure form. The programmable logic controller also includes a response information transmitter to transmit, when the read request information is received, response information being information responding to the read request information to the external device. The response information transmitter transmits the read-target information as the response information when the read-target information includes no confidential information, and transmits, as the response information, the read-target information with the confidential information replaced with the secured information when the read-target information includes the confidential information.

### Advantageous Effects of Invention

The programmable logic controller according to the above aspect of the present disclosure receiving read request information transmits, when the read-target information includes confidential information, the read-target information with the confidential information replaced with secured information as response information. The programmable logic controller according to the above aspect of the present disclosure can thus protect the confidential information from third parties without authenticating external devices. The programmable logic controller according to the aspect of the present disclosure can have a lower processing load than a programmable logic controller that performs authentication each time receiving read request information from an external device to protect confidential information from third parties. The programmable logic controller according to the aspect of the present disclosure can thus reduce the processing load while protecting information to be confidential from third parties.

### BRIEF DESCRIPTION OF DRAWINGS

FIG. 1 is a diagram of a PLC according to Embodiment 1 connected with an external device;

FIG. 2 is a diagram of the PLC according to Embodiment 1 illustrating the functional components;

FIG. 3 is a block diagram of the PLC according to Embodiment 1 illustrating the hardware configuration;

FIG. 4 is a diagram of information stored in a RAM in the PLC according to Embodiment 1;

FIG. 5 is a flowchart of confidential range determination process in Embodiment 1;

FIG. 6 is a flowchart of write control process in Embodiment 1;

FIG. 7 is a flowchart of read control process in Embodiment 1;

FIG. 8 is a flowchart continuous from the flowchart in FIG. 7;

FIG. 9 is a timing chart illustrating information reading from a device in a known PLC performed by an external device; and

FIG. 10 is a timing chart illustrating information reading from the PLC according to Embodiment 1 performed by an external device.

### DESCRIPTION OF EMBODIMENTS

A programmable logic controller (PLC), a control method, and a program according to one or more embodiments of the present disclosure are described below in detail with reference to the drawings. Like reference signs denote the like or corresponding components in the drawings.

### Embodiment 1

### PLC 100 According to Embodiment 1

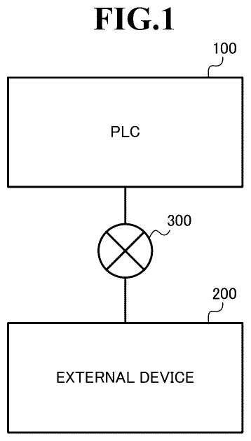

A PLC 100 according to Embodiment 1 of the present disclosure is, for example, a control apparatus that controls equipment such as machine tools and manufacturing devices that automate production processes in a factory. As illustrated in FIG. 1, the PLC 100 can transmit and receive information to and from an external device 200 in a production monitoring system through an Internet 300 that is an example of a communication network.

The PLC 100 stores production monitoring information for monitoring the production of products, such as control information about the equipment described above and recipe information about materials inside the equipment. The external device 200 frequently reads and writes these items of information from and to the PLC 100. For example, to cause the PLC 100 to store write-target information to be written, the external device 200 transmits write request information indicating a request for writing the write-target information to the PLC 100. In this case, upon receiving the write request information from the external device 200, the PLC 100 performs authentication of the external device 200 and stores, when the external device 200 is authenticated, the write-target information based on the write request information.

For example, when the PLC 100 stores read-target information to be read, the external device 200 transmits read request information indicating a request for reading the read-target information to the PLC 100. In this case, after receiving the read request information from the external device 200, the PLC 100 transmits response information responding to the read request information to the external device 200. The read-target information may include information to be confidential, such as know-how information, from third parties. To protect information to be confidential from third parties, the PLC 100 can select between performing and not performing authentication of the external device 200 after receiving the read request information from the external device 200.

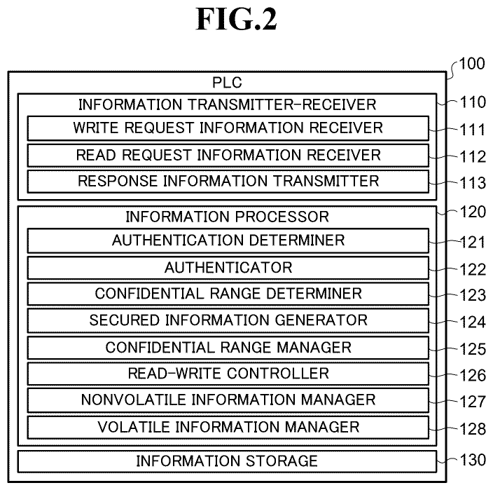

As illustrated in FIG. 2, the PLC 100 includes an information transmitter-receiver 110 that transmits and receives information, an information processor 120 that processes information, and an information storage 130 that stores information. The information transmitter-receiver 110 includes a write request information receiver 111 that receives write request information, a read request information receiver 112 that receives read request information, and a response information transmitter 113 that transmits response information.

The information processor 120 includes an authentication determiner 121 that determines whether to perform authentication, an authenticator 122 that performs authentication, a confidential range determiner 123 that determines the confidential range of write-target information, and a secured information generator 124 that generates secured information. The information processor 120 also includes a confidential range manager 125 that manages confidential information that is information in the confidential range, and a read-write controller 126 that controls read-write of information. The information processor 120 also includes a nonvolatile information manager 127 that manages nonvolatile information stored in a nonvolatile storage device and a volatile information manager 128 that manages volatile information stored in a volatile storage device.

The information storage 130 includes, for example, the volatile storage device such as a random-access memory (RAM) and the nonvolatile storage device such as a hard disk drive (HDD).

### Hardware Configuration of PLC 100 According to Embodiment 1

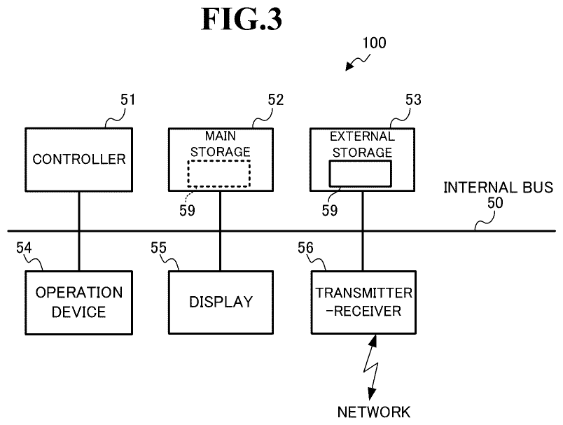

As illustrated in FIG. 3, the PLC 100 includes a controller 51 that performs processing based on a control program 59. The controller 51 includes a central processing unit (CPU). The controller 51 functions as the information processor 120 illustrated in FIG. 2 based on the control program 59.

Referring back to FIG. 3, the PLC 100 includes a main storage 52 into which the control program 59 is loaded. The main storage 52 is used as a work area for the controller 51. The main storage 52 includes a volatile storage device such as a RAM. The main storage 52 functions as the information storage 130 illustrated in FIG. 2.

Referring back to FIG. 3, the PLC 100 includes an external storage 53 prestoring the control program 59. The external storage 53 provides data stored in the program to the controller 51 and stores data provided from the controller 51 as instructed by the controller 51. The external storage 53 includes a nonvolatile storage device such as a flash memory, an HDD, or a solid-state dive (SSD). The external storage 53 functions as the information storage 130 illustrated in FIG. 2.

Referring back to FIG. 3, the PLC 100 includes an operation device 54 operable by the user. Information input through the operation device 54 is provided to the controller 51. The operation device 54 includes information input components such as a keyboard, a mouse, and a touchscreen.

The PLC 100 also includes a display 55 that displays information input through the operation device 54 and information output from the controller 51. The display 55 is, for example, a liquid crystal display (LCD) or an organic electroluminescent (EL) display.

The PLC 100 also includes a transmitter-receiver 56 that transmits and receives information. The transmitter-receiver 56 includes information communication components such as a network terminal device or a wireless communication device connected to a network. The transmitter-receiver 56 functions as the information transmitter-receiver 110 illustrated in FIG. 2.

Referring back to FIG. 3, in the PLC 100, the main storage 52, the external storage 53, the operation device 54, the display 55, and the transmitter-receiver 56 are connected to the controller 51 with an internal bus 50.

The PLC 100 implements the functions of the components 111 to 113, 121 to 128, and 130 illustrated in FIG. 2 with the controller 51 using the main storage 52, the external storage 53, the operation device 54, the display 55, and the transmitter-receiver 56 as resources. For example, the PLC 100 receives write request information through the write request information receiver 111. For example, the PLC 100 receives read request information through the read request information receiver 112 and transmits response information through the response information transmitter 113.

For example, the PLC 100 determines whether to perform authentication with the authentication determiner 121 and performs authentication with the authenticator 122. For example, the PLC 100 determines a confidential range with the confidential range determiner 123 and generates secured information with the secured information generator 124. For example, the PLC 100 manages confidential information with the confidential range manager 125 and controls reading and writing with the read-write controller 126. For example, the PLC 100 manages nonvolatile information with the nonvolatile information manager 127 and manages volatile information with the volatile information manager 128.

Details of Functional Components of PLC 100 According to Embodiment 1

Referring back to FIG. 2, the write request information receiver 111 receives write request information from the external device 200. The write request information includes, for example, write-target information, information allowing identification of confidential information included in the write-target information, and information allowing determination as to whether the write-target information is to be stored as nonvolatile information. The information allowing determination as to whether the write-target information is to be stored as nonvolatile information allows, for example, determination as to whether the information is to be stored as file information that is an example of nonvolatile information. The write request information further includes information for authentication used in authentication of the external device 200. The information for authentication indicates, for example, the user name and the password of the external device 200.

The read request information receiver 112 receives read request information from the external device 200. The read request information includes, for example, information allowing identification of read-target information. When the read request information receiver 112 pre-acquires information allowing determination that the external device 200 transmitting a read request is to be authenticated, the read request information further includes the information for authentication described above.

The response information transmitter 113 transmits response information generated by the read-write controller 126 (described later) to the external device 200.

When receiving write request information from the external device 200, the authentication determiner 121 determines to perform authentication. When receiving read request information from external device 200, the authentication determiner 121 determines whether to perform authentication based on preset read authentication selection information for selecting between performing or not performing authentication upon a read request. The read authentication selection information indicates the on or off state of the authentication that is set based on input performed by the user using the operation device 54.

When authentication is determined to be performed, the authenticator 122 performs authentication of the external device 200. For example, the authenticator 122 performs authentication of the external device 200 based on the information for authentication included in the received write request information or read request information. In the present embodiment, the external device 200 transmits write request information including information for authentication or read request information including information for authentication. In some embodiments, the external device 200 may transmit information for authentication separately from write request information or read request information.

When the external device 200 is authenticated, the confidential range determiner 123 determines the confidential range of the write-target information based on information allowing identification of confidential information included in the write-target information. The confidential range determiner 123 outputs information indicating the determined confidential range of the write-target information to the confidential range manager 125 (described later).

The secured information generator 124 generates secured information by converting the confidential information into a secure form. When the read-write controller 126 (described later) controls writing of write-target information, the secured information generator 124 generates secured information by encrypting the write-target information using pre-acquired public key information indicating the public key of the user of the external device 200. When the read-write controller 126 controls reading of read-target information, the secured information generator 124 generates secured information by converting the confidential information into indefinite information disabling identification of the confidential information. The indefinite information is, for example, random number information based on random numbers generated with an algorithm for generating pseudorandom numbers. The indefinite information may be any information other than random number information that disables identification of confidential information, and may be hash information based on the hash values of the confidential information.

The confidential range manager 125 manages confidential information based on information indicating the confidential range of the write-target information acquired from the confidential range determiner 123. The confidential range manager 125 identifies confidential information from information pieces stored in the information storage 130.

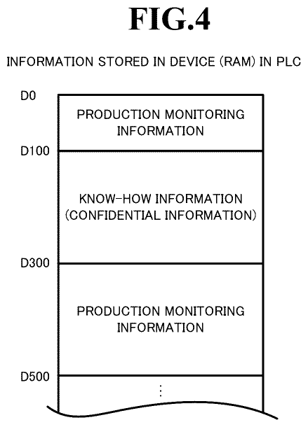

In the example below, the volatile storage device that is an example device is a RAM. As illustrated in FIG. 4, the RAM stores production monitoring information that is not confidential information in the memory areas from D0 to D99, know-how information that is confidential information in the memory areas from D100 to D299, and production monitoring information that is not confidential information in the memory areas from D300 to D499. In this case, the confidential range manager 125 identifies the information stored in the storage areas from D100 to D299 as confidential information.

To perform this control, the confidential range manager 125 outputs information indicating the confidential range of the write-target information to the read-write controller 126 before the write-target information is written, and then acquires the information indicating the confidential range from the read-write controller 126 after the write-target information is written. Thus, for example, the confidential range manager 125 can output, for reading read-target information, information allowing identification of any confidential information included in the read-target information to the read-write controller 126 based on the information indicating the confidential range when acquiring information allowing identification of the read-target information from the read-write controller 126.

Referring back to FIG. 2, for write request information received from the external device 200, the read-write controller 126 acquires, after the external device 200 is authenticated, information indicating the confidential range of the write-target information from the confidential range manager 125. When the write-target information includes confidential information, the read-write controller 126 causes the secured information generator 124 to generate secured information by converting the confidential information into a secure form and acquires the write-target information with the confidential information replaced with the secured information. The read-write controller 126 determines, based on the write request information, whether the write-target information is to be stored as nonvolatile information.

When the write-target information is to be stored as nonvolatile information, the read-write controller 126 causes the nonvolatile information manager 127 to write or import the write-target information. When the write-target information is to be stored as volatile information, the read-write controller 126 causes the volatile information manager 128 to import the write-target information.

For read request information received from the external device 200, the read-write controller 126 causes, when the read-target information is nonvolatile information stored in the nonvolatile storage device, the nonvolatile information manager 127 to read or export the read-target information. When the read-target information is volatile information stored in the volatile storage device, the read-write controller 126 causes the volatile information manager 128 to export the read-target information. The read-write controller 126 outputs information allowing identification of the read-target information to the confidential range manager 125 and acquires information allowing identification of any confidential information included in the read-target information.

When the read-target information includes no confidential information, the read-write controller 126 generates the read-target information that includes no confidential information as response information and causes the response information transmitter 113 to transmit the response information. When the read-target information includes confidential information, with the external device 200 being authenticated, the read-write controller 126 generates, as response information, the read-target information including the confidential information and causes the response information transmitter 113 to transmit the response information. The confidential information is encrypted using public key information.

When the read-target information includes confidential information, without the external device 200 being authenticated or with determination of not performing authentication, the read-write controller 126 causes the secured information generator 124 to generate secured information by converting the confidential information into indefinite information. The read-write controller 126 then generates, as response information, the read-target information with the confidential information replaced with the secured information and causes the response information transmitter 113 to transmit the response information.

The nonvolatile information manager 127 manages import and export of volatile information to and from the nonvolatile storage device in the information storage 130. When the read-write controller 126 controls writing of write-target information to the nonvolatile storage device, the nonvolatile information manager 127 imports the write-target information as nonvolatile information to the nonvolatile storage device. When the read-write controller 126 controls reading of read-target information from the nonvolatile storage device, the nonvolatile information manager 127 exports the read-target information as nonvolatile information from the nonvolatile storage device.

The volatile information manager 128 manages import and export of volatile information to and from the volatile storage device in the information storage 130. When the read-write controller 126 controls writing of write-target information to the volatile storage device, the volatile information manager 128 imports the write-target information as volatile information to the volatile storage device. When the read-write controller 126 controls reading of read-target information from the volatile storage device, the volatile information manager 128 exports the read-target information as volatile information from the volatile storage device.

### Confidential Range Determination Process in Embodiment 1

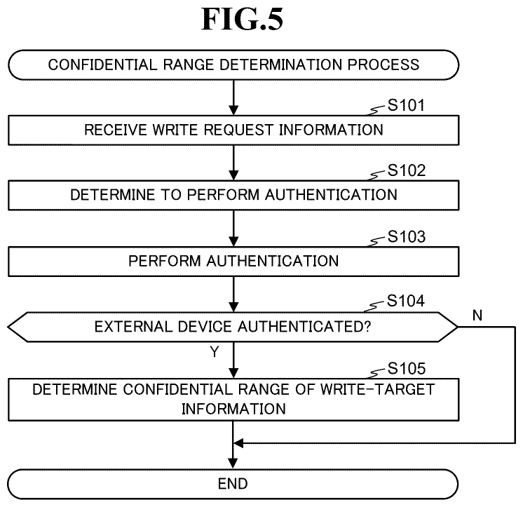

The operation of the PLC 100 performed to determine the confidential range of write-target information is described below with reference to a flowchart. When being turned on, the PLC 100 starts the confidential range determination process illustrated in FIG. 5. The write request information receiver 111 first receives write request information from the external device 200 (step S101). The authentication determiner 121 determines to perform authentication (step S102), The authenticator 122 then performs authentication of the external device 200 (step S103). The confidential range determiner 123 determines whether the external device 200 is authenticated (step S104).

When the external device 200 is unauthenticated (N in step S104), the confidential range determiner 123 ends the process without determining the confidential range. When the external device 200 is authenticated (Y in step S104), the confidential range determiner 123 determines the confidential range of the write-target information (step S105) based on information allowing identification of the confidential information included in the write-target information, and ends the process.

### Write Control Process in Embodiment 1

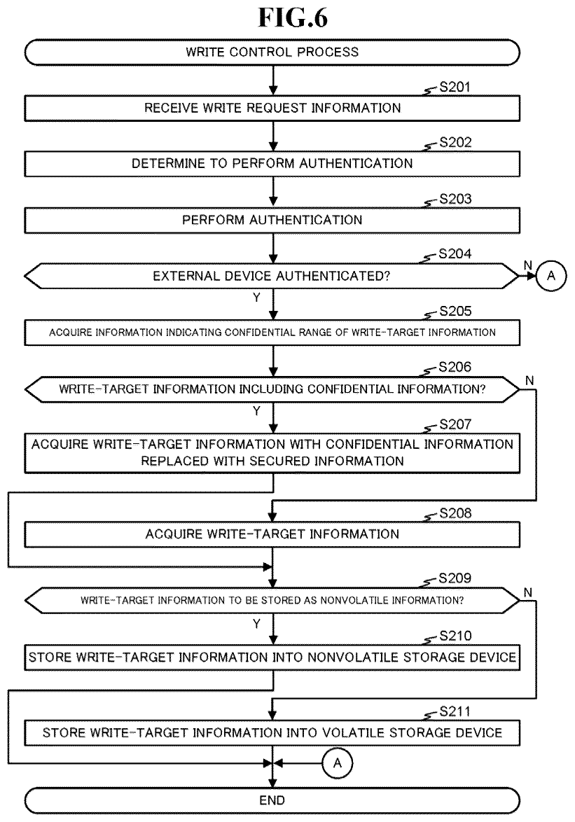

The operation of the PLC 100 performed to control writing of write-target information is described below with reference to a flowchart. When being turned on, the PLC 100 starts the write control process illustrated in FIG. 6. The write request information receiver 111 first receives write request information from the external device 200 (step S201). The authentication determiner 121 determines to perform authentication (step S202). The authenticator 122 then performs authentication of the external device 200 (step S203). The read-write controller 126 determines whether the external device 200 is authenticated (step S204).

When the external device 200 is unauthenticated (N in step S204), the read-write controller 126 ends the process without writing the write-target information. When the external device 200 is authenticated (Y in step S 204), the read-write controller 126 acquires information indicating the confidential range of the write-target information from the confidential range manager 125 (step S205) and determines whether the write-target information includes confidential information (step S206).

When the write-target information includes confidential information (Y in step S206), the read-write controller 126 causes the secured information generator 124 to generate secured information by converting the confidential information into a secure form and acquires the write-target information with the confidential information replaced with the secured information (step S207). When the write-target information includes no confidential information (N in step S206), the read-write controller 126 acquires write-target information including confidential information (step S208). The read-write controller 126 then determines, based on the write request information, whether the write-target information is to be stored as nonvolatile information (step S209).

When the write-target information is to be stored as nonvolatile information (Y in step S209), the read-write controller 126 causes the nonvolatile information manager 127 to store or import the write-target information into the nonvolatile storage device (step S210) and ends the process. When the write-target information is to be stored as volatile information (N in step S209), the read-write controller 126 causes the volatile information manager 128 to store or import the write-target information into the volatile storage device (step S211) and ends the process.

### Read Control Process in Embodiment 1

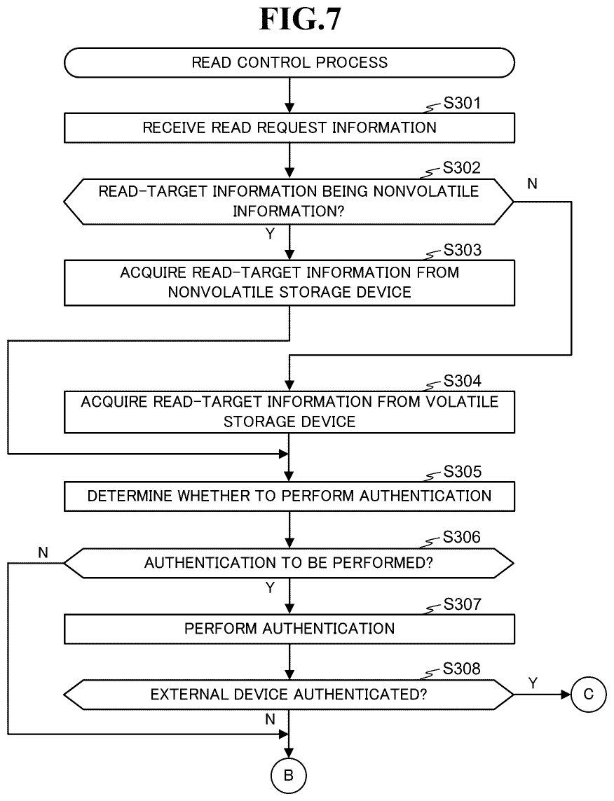

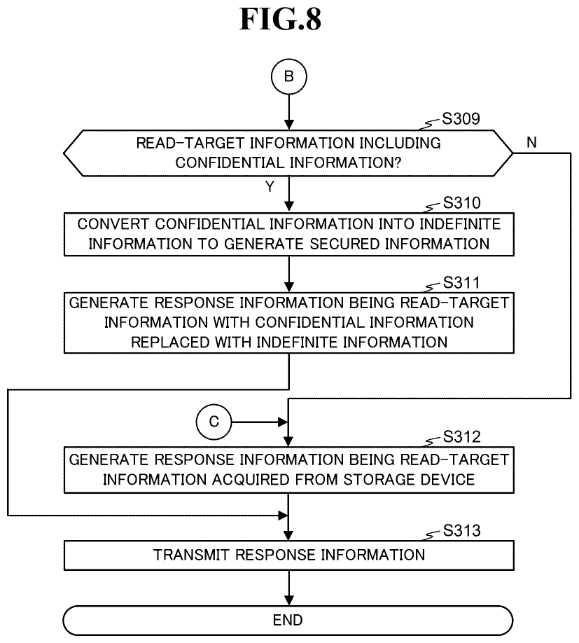

The operation of the PLC 100 performed to control reading of read-target information is described below with reference to a flowchart. When being turned on, the PLC 100 starts the read control process illustrated in FIGS. 7 and 8. As illustrated in FIG. 7, the read request information receiver 112 first receives read request information from the external device 200 (step S301). The read-write controller 126 determines, based on the read request information, whether the read-target information is nonvolatile information (step S302).

When the read-target information is nonvolatile information (Y in step S302), the read-write controller 126 causes the nonvolatile information manager 127 to acquire or export the read-target information from the nonvolatile storage device (step S303). When the read-target information is volatile information (N in step S302), the read-write controller 126 causes the volatile information manager 128 to acquire or export the read-target information from the volatile storage device (step S304). The read-write controller 126 then causes the authentication determiner 121 to determine whether to perform authentication based on authentication selection information (step S305) and determines whether the authentication is determined to be performed (step S306).

When the authentication is determined to be performed (Y in step S306), the read-write controller 126 causes the authenticator 122 to perform authentication of the external device 200 (step S307) and determines whether the external device 200 is authenticated (step S308). When the external device 200 is unauthenticated (N in step S308), or when the authentication is determined not to be performed (N in step S306), the read-write controller 126 determines, based on information acquired from the confidential range manager 125, whether the read-target information includes confidential information, as illustrated in FIG. 8 (step S309).

When the read-target information includes confidential information (Y in step S309), the read-write controller 126 causes the secured information generator 124 to convert the confidential information into indefinite information to generate secured information (step S310). The read-write controller 126 then generates response information that is the read-target information with the confidential information replaced with the secured information (step S311). When the read-target information includes no confidential information (N in step S309), or when the external device 200 is authenticated (Y in step S308), the read-write controller 126 generates response information that is the read-target information acquired from the storage device in the information storage 130 (step S312). The read-write controller 126 then causes the response information transmitter 113 to transmit the generated response information (step S313) and ends the process.

As described above, in the PLC 100 according to the present embodiment, the read request information receiver 112 receives read request information for reading read-target information from the external device 200. When the read-target information includes confidential information, the secured information generator 124 generates secured information by converting the confidential information into a secure form. When the read-target information includes no confidential information, the response information transmitter 113 transmits the read-target information as response information. When the read-target information includes confidential information, the response information transmitter 113 transmits, as response information, the read-target information with the confidential information replaced with secured information.

In the manner described above, the PLC 100 according to the present embodiment can protect confidential information from third parties without authenticating the external device 200 and can have a lower processing load than a PLC that performs authentication each time receiving read request information from an external device. The programmable logic controller according to one or more embodiments of the present disclosure can thus reduce the processing load while protecting information to be confidential from third parties.

In the PLC 100 according to the present embodiment, the authentication determiner 121 determines whether to perform authentication of the external device 200 upon receiving read request information. The authenticator 122 performs authentication of the external device 200 when authentication is determined to be performed. When authentication is determined not to be performed and the read-target information includes confidential information, the response information transmitter 113 transmits, as response information, the read-target information with the confidential information replaced with secured information.

In the manner described above, the PLC 100 according to the present embodiment can select between performing and not performing authentication of the external device 200 upon receiving read request information. The PLC 100 according to the present embodiment can protect confidential information from third parties also when the PLC selects not to perform authentication.

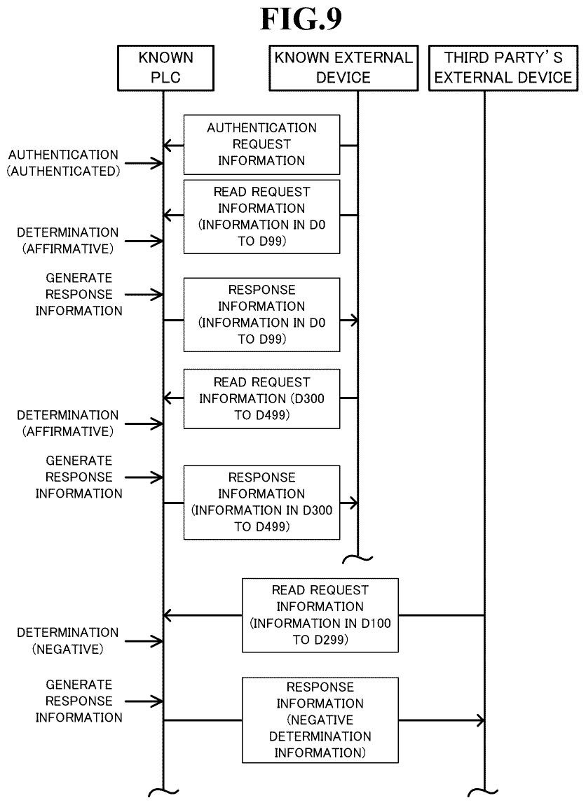

With a known PLC such as the PLC described in Patent Literature 1, when a known external device in a production monitoring system reads information stored in a device, as illustrated in FIG. 9, the known external device first transmits authentication request information indicating a request for authentication. After receiving the request information, the known PLC performs authentication of the known external device and authenticates the external device. The authenticated known external device then transmits read request information. After receiving the read request information, the known PLC determines whether the read-target information includes confidential information. When the determination result is affirmative, the PLC transmits response information to the known external device. The known PLC stores write-target information in the device without encrypting confidential information. To prevent unauthenticated external devices from reading confidential information, the known PLC performs the determination each time receiving read request information.

For example, for the device being the RAM illustrated in FIG. 4, the read-target information includes no confidential information when the read-target information is the production monitoring information stored in the storage areas from D0 to D99 or from D300 to D499. In this case, as illustrated in FIG. 9, the determination result is affirmative, and the known PLC generates the read-target information as response information and transmits the response information to the known external device. When the read-target information is the know-how information stored in the storage areas from D100 to D299, the read-target information includes confidential information. The known PLC thus generates, unless the known external device is authenticated, negative determination information indicating that the determination result is negative as response information and transmits the response information to the known external device.

The known PLC performs authentication and the determination each time information is to be read by the known external device. This causes information to be read in short cycles with a higher processing load. The known PLC may thus have, for example, a higher latency from when receiving read request information to when transmitting response information, or take a longer time to scan information stored in the device. The known PLC with the higher processing load when reading and writing information to and from the device may further cause processing delays in the sequence control of the PLC.

Typically, the known external device collectively reads information stored in a range of storage areas from the device to increase communication efficiency. The known PLC performs authentication before reading when the information stored in the device includes confidential information. The known PLC may include multiple types of devices, with some storing information including confidential information involving authentication for reading and the others storing information including no confidential information involving no authentication. To efficiently read information from each device, the known external device may use separate programs for collectively reading information from a device involving no authentication and for reading information in segments from a device involving authentication.

Thus, when the known external device reads production monitoring information from, for example, the RAM illustrated in FIG. 4, the external device uses the program for reading information in segments to read the production monitoring information stored in the storage areas from D0 to D99 and from D300 to D499, as illustrated in FIG. 9. In this case, the known PLC is less efficient in communication than when using the program for collectively reading information.

Furthermore, as illustrated in FIG. 9, the known PLC transmits, unless the known external device is authenticated, the negative determination information to the known external device as response information when the read-target information includes confidential information. When the known external device receiving the negative determination information as response information is used by a malicious third party, the third party can notice that confidential information is stored in the storage area of the device in which the read-target information is stored. The known PLC can thus provide information useful for stealing confidential information to third parties by transmitting the negative determination information as response information. The PLC can be an easy hacking target.

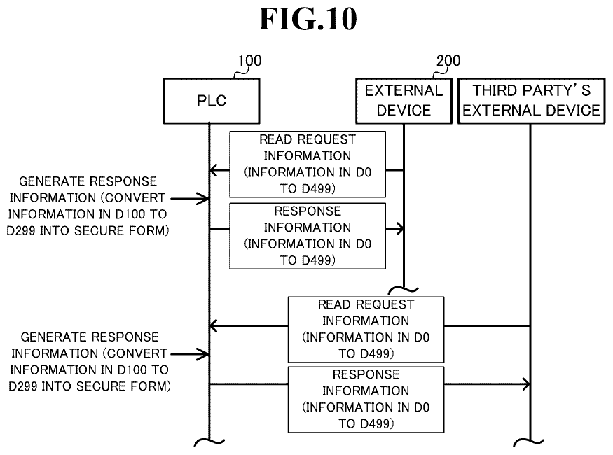

In contrast, with the PLC 100 according to the present embodiment, as illustrated in FIG. 10, the external device 200 to read information stored in the device first transmits read request information without transmitting authentication request information. After receiving the read request information, the PLC 100 generates response information based on the read-target information and transmits the information to the external device 200, independently of whether the read-target information includes confidential information.

This allows the PLC according to the present embodiment to avoid performing authentication or the determination, unlike the known PLC that performs the authentication and the determination each time information is to be read by the external device 200. The PLC according to the present embodiment thus has a lower processing load than the known PLC, with a lower latency from when receiving read request information to when transmitting response information and a shorter time for scanning information stored in the device.

When the read-target information includes confidential information, the PLC 100 according to the present embodiment can transmit, as response information, the read-target information with the confidential information replaced with secured information. The external device 200 can thus collectively read read-target information efficiently from each device without using separate programs for collectively reading information from a device involving no authentication and for reading information in segments from a device involving authentication.

Thus, when reading production monitoring information from, for example, the RAM illustrated in FIG. 4, the external device 200 may collectively read the production monitoring information stored in the storage areas from D0 to D499, as illustrated in FIG. 10. The PLC 100 according to the present embodiment can thus have higher communication efficiency than the known PLC that reads information in segments from a device involving authentication.

When the read-target information includes confidential information, the external device 200 receives, as response information, the read-target information with the confidential information replaced with secured information. Thus, when the external device 200 receiving the response information is used by a malicious third party, the third party cannot notice that the read-target information includes confidential information unless identifying secured information included in the response information. The PLC 100 according to the present embodiment thus does not provide useful information for stealing confidential information to third parties. The PLC 100 is less likely to be a hacking target than the known PLC.

In the PLC 100 according to the present embodiment, the write request information receiver 111 receives write request information for writing write-target information from the external device 200. When receiving the write request information, the authentication determiner 121 determines to perform authentication. The authenticator 122 performs authentication of the external device 200. When the external device 200 is authenticated, the confidential range determiner 123 determines the confidential range of the write-target information. The information storage 130 stores the write-target information with the confidential range determined.

In the manner described above, the PLC 100 according to the present embodiment can limit the user who can specify the confidential range of write-target information using the external device 200. This allows the PLC 100 according to the present embodiment to convert confidential information into a secure form less frequently and have a lower processing load than a PLC that determines the confidential range and convert the information in the range into a secure form each time the PLC receives write request information without performing authentication of external devices.

In the PLC 100 according to the present embodiment, the secured information generator 124 generates secured information by encrypting the confidential information included in write-target information. The information storage 130 stores the write-target information with the confidential information replaced with the secured information.

In the manner described above, the PLC 100 according to the present embodiment can maintain the confidentiality of the information stored in the information storage 130 against any unauthorized access from third parties'external devices resulting from vulnerability such as defects in the installed program.

When the external device 200 is authenticated and the read-target information includes confidential information, the PLC 100 according to the present embodiment transmits, as response information, the read-target information with the confidential information encrypted. The encrypted confidential information can be decrypted by the external device 200 that has transmitted write request information for writing write-target information including the confidential information. For example, the secured information generator 124 encrypts the confidential information using public key information, whereas the external device 200 decrypts the encrypted confidential information using private key information indicating the private key corresponding to the public key indicated by the public key information.

In the manner described above, with the PLC 100 according to the present embodiment, the user of the external device 200 that has caused the read-target information to be written to the PLC 100 can decrypt the encrypted confidential information included in the read-target information and identify the information in the confidential range. The PLC 100 can thus maintain the confidentiality of the confidential information.

In the PLC 100 according to the present embodiment, the information storage 130 includes the volatile storage device. The write request information receiver 111 receives, from the external device 200, write request information for writing write-target information to the volatile storage device. The read request information receiver 112 receives, from the external device 200, read request information for reading read-target information stored in the volatile storage device. In other words, the PLC 100 according to the present embodiment allows reading and writing of volatile information from and to the volatile storage devices, or for example, allows reading and writing of volatile information in each storage area of the RAM.

In the manner described above, the PLC 100 according to the present embodiment can appropriately protect information for monitoring the production of products, such as the equipment control information and recipe information described above stored in a device such as a RAM.

In the PLC 100 according to the present embodiment, the information storage 130 includes the nonvolatile storage device. The write request information receiver 111 receives, from the external device 200, write request information for writing write-target information to the nonvolatile storage device. The read request information receiver 112 receives, from the external device 200, read request information for reading read-target information stored in the nonvolatile storage device. In other words, the PLC 100 according to the present embodiment allows reading and writing of nonvolatile information from and to the nonvolatile storage devices, or for example, allows reading and writing of nonvolatile information in each file stored in, for example, an HDD.

In the manner described above, the PLC 100 according to the present embodiment can store and save, for example, information for monitoring the production of products, such as the equipment control information and the recipe information described above, into the HDD as nonvolatile file information. The PLC 100 according to the present embodiment can thus save information for monitoring the production during, for example, any power outage causing a dead battery.

In the PLC 100 according to the present embodiment, the secured information generator 124 generates secured information by converting the confidential information included in read-target information into indefinite information. When the read-target information includes confidential information, the response information transmitter 113 can transmit, as response information, the read-target information with the confidential information replaced with indefinite information. In other words, the PLC 100 according to the present embodiment can replace the confidential information included in the response information with unreconstructable dummy data.

In the manner described above, the PLC 100 according to the present embodiment can have a lower processing load to convert confidential information into a secure form and have a lower latency than a PLC that does not generate secured information by converting confidential information into indefinite information.

### Modifications

In the above embodiment, when the read-target information includes confidential information, the PLC 100 transmits, unless the external device 200 is authenticated, the read-target information with the confidential information replaced with indefinite information as response information. The secured information is not limited to the indefinite information. For example, the PLC 100 may transmit, as response information, the read-target information with the confidential information encrypted. In this case, the PLC 100 can use the information stored in the information storage 130 as response information without processing the information. The PLC 100 can thus skip the processes of determining whether the read-target information includes confidential information, generating indefinite information as secured information, and replacing confidential information with indefinite information.

In the above embodiment, when the read-target information includes confidential information, the PLC 100 transmits, unless the external device 200 is authenticated, the read-target information with the confidential information replaced with secured information as response information. The information to be converted into a secure form is not limited to confidential information. For example, the PLC 100 may transmit, as response information, read-target information with all the information items encrypted, including confidential information and information different from the confidential information. In this case, the external device 200 in the production monitoring system is to decrypt the received encrypted read-target information, whereas an external device used by a third party is to be prevented from decrypting the received encrypted read-target information to protect the confidential information from the third party.

In the above embodiment, when the read-target information includes confidential information, the PLC 100 transmits, with the external device 200 being authenticated, the information stored in the information storage 130 as response information. The response information transmitted with the external device 200 being authenticated is not limited to the information stored in the information storage 130. For example, the PLC 100 may transmit, as response information, read-target information with the encrypted confidential information replaced with decrypted confidential information. To perform such control, the PLC 100 is to decrypt encrypted confidential information.

To protect confidential information from unauthorized access, as in the above embodiment, the PLC 100 may store, when the write-target information includes confidential information, the write-target information with the confidential information replaced with secured information into the information storage 130. However, the write-target information may be stored in another manner. For example, the PLC 100 may store the write-target information into the information storage 130 without replacing the confidential information with secured information. In this case as well, when the read-target information includes confidential information, the PLC 100 can transmit, as response information, the read-target information with the confidential information replaced with secured information to the external device 200 that is unauthenticated. In this case, the PLC 100 may transmit, as response information, the read-target information without encrypting the confidential information when the external device 200 is authenticated. In this case, the PLC 100 can use the information stored in the information storage 130 as response information without processing the information.

In the above embodiment, the PLC 100 receiving read request information can select between performing and not performing authentication of the external device 200. In some embodiments, the PLC 100 may not be allowed to select between performing and not performing authentication of the external device 200. For example, the PLC 100 may perform authentication of the external device 200 each time receiving read request information. For example, the PLC 100 may not perform authentication of the external device 200 upon receiving the read request information.

Although the PLC 100 may perform authentication of the external device 200 each time receiving write request information to limit the user who can specify the confidential range as in the above embodiment, the PLC 100 may not perform authentication of the external device 200 each time receiving write request information. For example, the PLC 100 may select between performing or not performing authentication of the external device 200 when receiving write request information as well as when receiving read request information. For example, the PLC 100 may not perform authentication of the external device 200 upon receiving write request information.

In the above embodiment, the PLC 100 performs authentication using a user name and a password. In some embodiments, authentication may be performed in another manner. For example, the PLC 100 may use known authentication techniques including authentication using digital certificates, two-step authentication using software on the user's mobile terminal such as smartphone applications, email, and Short Message Service (SMS) as well as the user name and password, and Fast Identity Online (FIDO) authentication using biometric information such as fingerprints and irises.

In the above embodiment, confidential information is encrypted using a known public-key cryptographic algorithm. In some embodiments, confidential information may be encrypted in another manner. For example, confidential information may be encrypted using a known symmetric-key cryptographic algorithm, Any cryptographic algorithm that allows the user of the external device 200 to decrypt the information may be used, such as a private cryptographic algorithm that does not use a key agreed between the PLC 100 and the external device 200.

As in the above embodiment, the PLC 100 may store file information in the nonvolatile storage device in a manner readable and writable by the external device 200 to save information for monitoring production as nonvolatile information. In some embodiments, the PLC 100 may store file information in another manner. For example, the PLC 100 may allow the external device 200 to read and write volatile information stored in the device while not allowing the external device 200 to read and write file information stored in the nonvolatile storage device.

The main part of the PLC 100 including the controller 51, the main storage 52, the external storage 53, the operation device 54, the transmitter-receiver 56, and the internal bus 50 may be implemented by installing the program for the above operation stored and distributed in a non-transitory recording medium readable by the PLC 100 such as a flash memory. This allows the PLC 100 to perform the processes described above. Such a program may be stored in a storage device included in a server device on a communication network such as a local area network (LAN) or the Internet, and may be downloaded by the PLC 100 to implement the functions of the PLC 100.

The functions of the PLC 100 may be implemented partially by the operating system (OS) and partially by an application program or through cooperation between the OS and the application program. In this case, functions executable by the application program other than the OS may be stored in a non-transitory recording medium or a storage device.

The program may also be superimposed on a carrier wave to be provided through a communication network. For example, the program may be posted on a bulletin board system (BBS) on a communication network to be provided through the network. The above processes may be performed by launching the program and executing the program under the control by the OS in the same manner as in another application program.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Reference Signs List

50 Internal bus
51 Controller
52 Main storage
53 External storage
54 Operation device
56 Transmitter-receiver
59 Control program
100 PLC
110 Information transmitter-receiver
111 Write request information receiver
112 Read request information receiver
113 Response information transmitter
120 Information processor
121 Authentication determiner
122 Authenticator
123 Confidential range determiner
124 Secured information generator
125 Confidential range manager
126 Read-write controller
127 Nonvolatile information manager
128 Volatile information manager
130 Information storage
200 External device
300 Internet

1. A programmable logic controller capable of transmitting and receiving information to and from an external device, the programmable logic controller comprising:
processing circuitry; and
a transmitter-receiver, wherein
the transmitter-receiver receives, from the external device, read request information indicating a request for reading read-target information, the read-target information being information to be read,
the processing circuitry generates, when the read-target information includes confidential information being information to be in a confidential range, secured information being the confidential information converted into a secure form, and
the transmitter-receiver
transmits, when the read request information is received, response information being information responding to the read request information to the external device, and
transmits the read-target information as the response information when the read-target information includes no confidential information, and transmits, as the response information, the read-target information with the confidential information replaced with the secured information when the read-target information includes the confidential information.

2. The programmable logic controller according to claim 1, wherein
the processing circuitry
determines whether to perform authentication of the external device when the read request information is received, and
performs the authentication of the external device when the authentication is determined to be performed, and
the transmitter-receiver transmits, as the response information, the read-target information with the confidential information replaced with the secured information when the authentication is determined not to be performed and the read-target information includes the confidential information.

3. The programmable logic controller according to claim 2, further comprising:
a storage, wherein
the transmitter-receiver receives, from the external device, write request information indicating a request for writing write-target information, the write-target information being information to be written,
the processing circuitry
determines to perform the authentication when the write request information is received, and
determines the confidential range of the write-target information when the external device is authenticated, and
the storage stores the write-target information with the confidential range determined.

4. The programmable logic controller according to claim 3, wherein
the processing circuitry generates the secured information by encrypting the confidential information included in the write-target information, and
the storage stores the write-target information with the confidential information replaced with the secured information.

5. The programmable logic controller according to claim 4, wherein
when the external device is authenticated and the read-target information includes the confidential information, the transmitter-receiver transmits, as the response information, the read-target information with the confidential information encrypted, and
the encrypted confidential information is decryptable by the external device that has transmitted the write request information for writing the write-target information including the confidential information.

6. The programmable logic controller according to claim 3, wherein
the storage includes a volatile storage device, and
the transmitter-receiver
receives, from the external device, the write request information for writing the write-target information to the volatile storage device, and
receives, from the external device, the read request information for reading the read-target information stored in the volatile storage device.

7. The programmable logic controller according to claim 3, wherein
the storage includes a nonvolatile storage device, and
the transmitter-receiver
receives, from the external device, the write request information for writing the write-target information to the nonvolatile storage device, and
receives, from the external device, the read request information for reading the read-target information stored in the nonvolatile storage device.

8. The programmable logic controller according to claim 1, wherein
the processing circuitry generates the secured information by converting the confidential information included in the read-target information into indefinite information disabling identification of the confidential information, and
when the read-target information includes the confidential information, the transmitter-receiver transmits, as the response information, the read-target information with the confidential information replaced with the indefinite information.

9. A control method, comprising:
receiving read request information from an external device, the read request information indicating a request for reading read-target information, the read-target information being information to be read;
generating secured information when the read-target information includes confidential information being information to be in a confidential range, the secured information being the confidential information converted into a secure form; and
transmitting the read-target information with the confidential information replaced with the secured information to the external device as response information when the programmable logic controller receives the read request information and the read-target information includes the confidential information, the response information being information responding to the read request information.

10. A non-transitory computer-readable recording medium storing a program, the program causing a programmable logic controller to execute processing comprising:
receiving, from an external device, read request information indicating a request for reading read-target information, the read-target information being information to be read;
generating, when the read-target information includes confidential information being information to be in a confidential range, secured information being the confidential information converted into a secure form; and
transmitting, when the read request information is received and the read-target information includes the confidential information, the read-target information with the confidential information replaced with the secured information to the external device as response information, the response information being information responding to the read request information.
